(19) United States
(12) Patent Application Publication
(10) Pub. No.: US 2006/0053668 A1
(43) Pub. Date: Mar. 16, 2006

(54) Posterboard display stand

(76) Inventors: Edward P. Busam, Mason, OH (US); Alison Victoria Busam, Mason, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/942,508

(22) Filed: Sep. 16, 2004

(51) Int. Cl. G09F 15/02

(52) U.S. Cl. 40/606.12

(57) ABSTRACT

A posterboard display stand system including a display stand configured to frictionally grip a posterboard along an edge thereof and to impart a curvature thereto when the posterboard is frictionally gripped therein. In another embodiment the invention is a posterboard display stand system including a backing portion and a movable portion shaped to be coupled to the backing portion. The movable portion is movable relative to the backing portion such that the backing portion and the movable portion can frictionally grip a posterboard therebetween and impart a curvature thereto.

The present invention is directed to a posterboard display stand, and particularly to a posterboard display stand which can securely receive a posterboard therein and lend stiffness to the posterboard.

### BACKGROUND

Posterboards are used in a variety of settings and manners. For example, posterboards may be used in an office environment to display text, drawings or images, or in a school environment for use with science projects, teaching aids, and the like. Because most posterboards are generally flat, thin sheets of paperboard, in order to display the posterboard the posterboard must typically be secured to a wall, a flat surface or the like to lend support. However, this manner of displaying posterboards limits the manner in which the posterboard can be displayed, and also limits the locations in which the posterboard can be utilized.

Thus, posterboard display stands may be utilized to provide a portable structure in which the posterboard can be displayed. However, many existing posterboard display stands are bulky, difficult to operate or do not secure and stably secure the posterboard therein. Accordingly, there is a need for an improved posterboard display stand.

### SUMMARY

In one embodiment, the present invention is a relatively lightweight posterboard display stand which is easy to operate and securely and stably receives a posterboard therein. In particular, in one embodiment the invention is a posterboard display stand system including a display stand configured to frictionally grip a posterboard along an edge thereof and to impart a curvature thereto when the posterboard is frictionally gripped therein. In another embodiment the invention is a posterboard display stand system including a backing portion and a movable portion shaped to be coupled to the backing portion. The movable portion is movable relative to the backing portion such that the backing portion and the movable portion can frictionally grip the lower edge of a posterboard therebetween and impart a curvature thereto.

Other objects and advantages of the present invention will be apparent from the following description and the accompanying drawings.

### BRIEF DESCRIPTION OF THE DRAWINGS

FIG. 1 is a top view of various components of one embodiment of the posterboard display stand, in an unassembled condition;

FIG. 2 is a top perspective view of the folded and arranged posterboard display stand components of FIG. 1, shown in an exploded configuration;

FIG. 3 is a top perspective view of the posterboard display stand components of FIG. 2, shown in an assembled condition;

FIG. 4 is a top perspective view of the posterboard display stand of FIG. 3, with a posterboard received therein;

FIG. 5 is a front perspective view of the posterboard display stand and posterboard of FIG. 4;

FIG. 6 is a top view of the posterboard display stand and posterboard of FIG. 4;

FIG. 7 is a front perspective view of the posterboard display stand and posterboard of FIG. 4, with the front flap in its folded configuration illustrating various components in hidden lines;

FIG. 8 is a front perspective view of the posterboard display stand and posterboard of FIG. 7, shown without the hidden line components;

FIG. 9 is a top view of the posterboard display stand and posterboard of FIG. 8;

FIG. 10 is a top view of various components of another embodiment of the posterboard display stand, in an unassembled condition;

FIG. 11 is a top view of the support portions of the posterboard display stand of FIG. 10 arranged for assembly;

FIG. 12 is a top view of the posterboard display stand portions of FIG. 11, with portions of one of the support portions being folded;

FIG. 13 is a top view of the posterboard display stand of FIG. 12, shown in its assembled state;

FIG. 14 is a top view of various components of another embodiment of the posterboard display stand, in coupled together for packaging or sale;

FIG. 15 is a top view of the components of FIG. 14 separated from each other and in an unassembled condition;

FIG. 16 is a top view of the support portions of the posterboard display stand of FIG. 15 arranged for assembly; and

FIG. 17 is a top view of the posterboard display stand of FIG. 16, shown in its assembled state.

### DETAILED DESCRIPTION

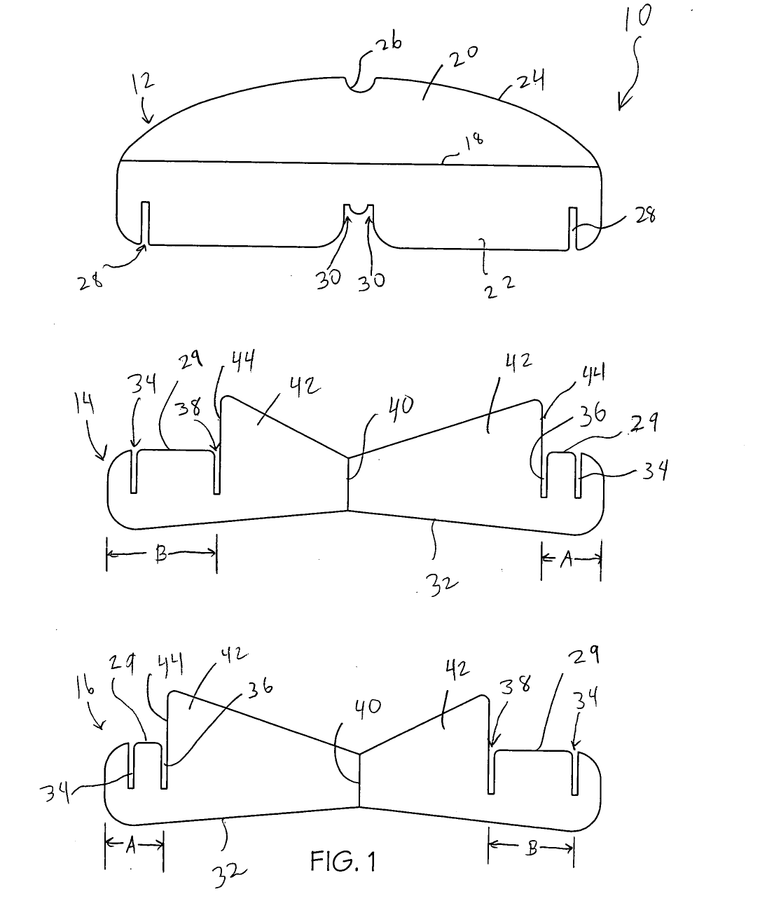

One embodiment of the posterboard display stand 10 is shown in its unassembled condition in FIG. 1. The posterboard display stand 10 includes a front flap 12 and a pair of support portions 14, 16. The front flap 12 includes a fold line 18 dividing the front flap 12 into a movable portion 20 and a body portion 22. The movable portion 20 has a curved outer edge or engagement surface 24 and a finger notch 26 formed in the center of the curved outer edge 24. The body portion 22 of the front flap 12 includes a pair of outer notches or slots 28 and a pair of inner notches or slots 30.

Each support portion 14, 16 includes a bottom edge 32 and a pair of opposed front or outer notches or slots 34 (also termed coupling slots) and a pair of opposed rear or inner notches or slots 36, 38. The first rear notch 36 of each support portion 14, 16 may be located closer to the outer edge of the support portion 14, 16 than the corresponding second rear notches 38. In other words, distance A measured from the first rear notches 36 to the adjacent outer edge is less than the distance B measured from the second rear notches 38 to the adjacent outer edge. Each support portion 14, 16 includes a laterally extending fold line 40. Each of the support portions 14, 16 further includes a pair of support vanes 42 defining a vertical support surface 44 extending upwardly from the associated rear notches 36, 38. A horizontal flap surface 29 is located between the notches 34, 36 and notches 34, 38.

The front flap 12 and the support portions 14, 16 are all preferably made of a generally flat, rigid material, such as corrugated cardboard, although the front flap 12 and support portions 14, 16 can be made of a wide variety of other materials, such as paper, cardboard, plastic and the like. If desired, the front flap 12 and support portions 14, 16 can all be formed in a single sheet of cardboard or the like, with perforation lines extending around the outer perimeters of the front flap 12 and support portion 14, 16. In this manner the sheet of cardboard can be torn or cut along the perforation lines to provide the front flap 12 and support portions 14, 16, and any leftover or waste material from the cardboard sheet can be discarded.

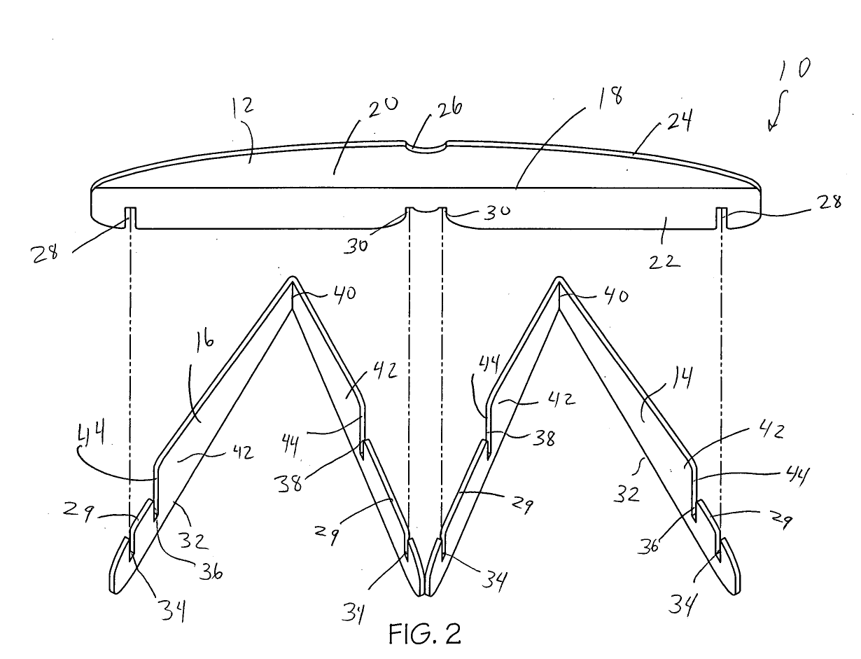

In order to assemble the posterboard display stand 10, each support portion 14, 16 is folded about its fold line 40 to form an acute angle, for example about 60 degrees. The bottom edges 32 of the support portions 14, 16 are then located on a horizontal support surface, such as a table, floor or the like (not shown). The folded support portions 14, 16 are located adjacent to each other to form a generally “M” shape shown in FIG. 2. Each of the first rear notches 36 are located on the outer legs of the “M” shape, and the second rear notches 38 are located adjacent to each other and on the inner legs of the “M” shape.

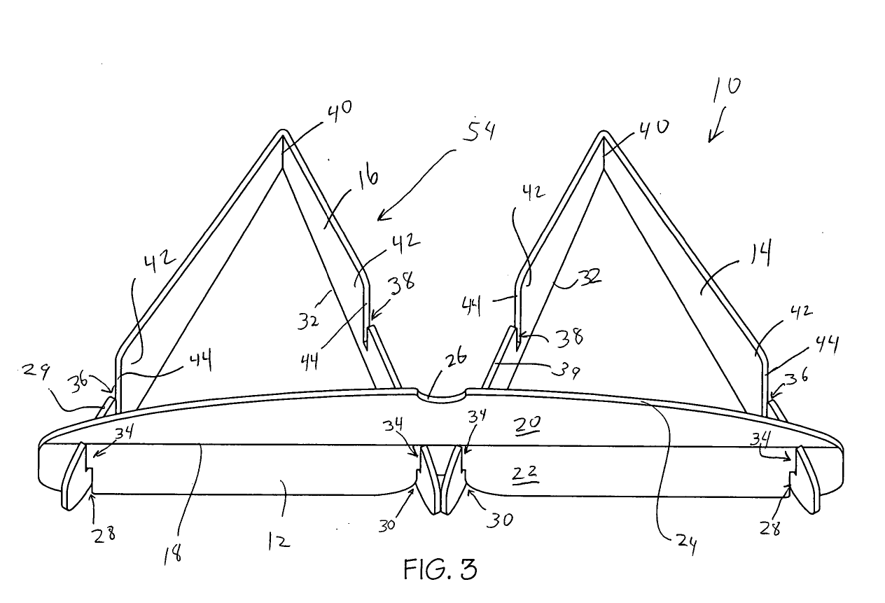

The front flap 12 is then located above the support portions 14, 16 in the configuration shown in FIG. 2. Next, the front flap 12 is lowered until its outer notches 28 and inner notches 30 are received in the four front notches 34 of the folded support portions 14, 16. In this manner, the front flap 12 is secured to the support portions 14, 16 and secured to support portions 14, 16 to each other to form the posterboard display stand 10 (FIG. 3).

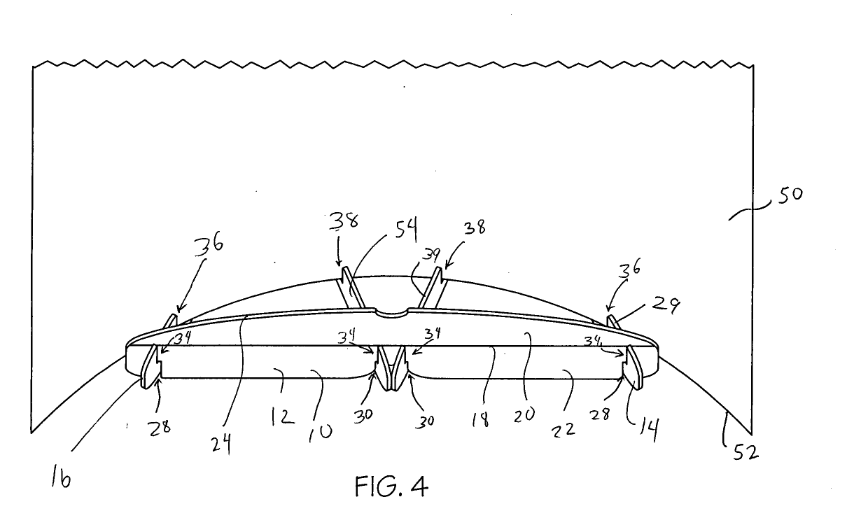

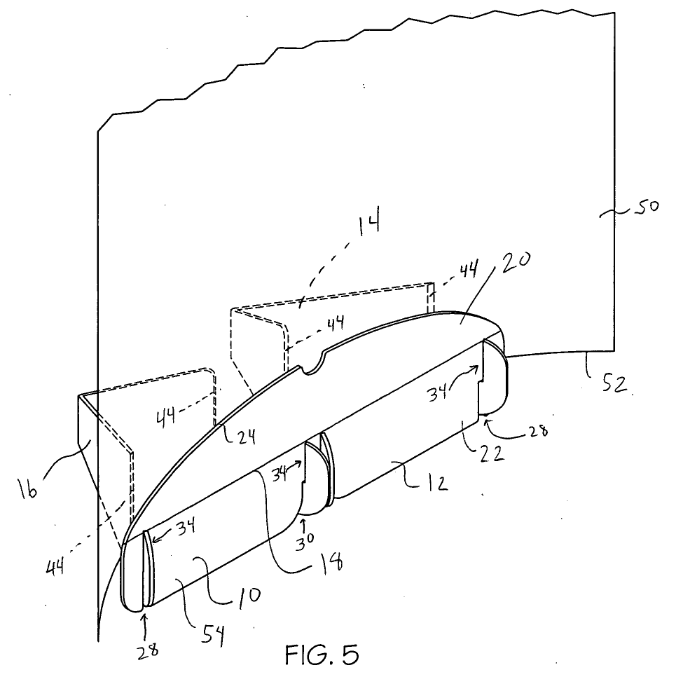

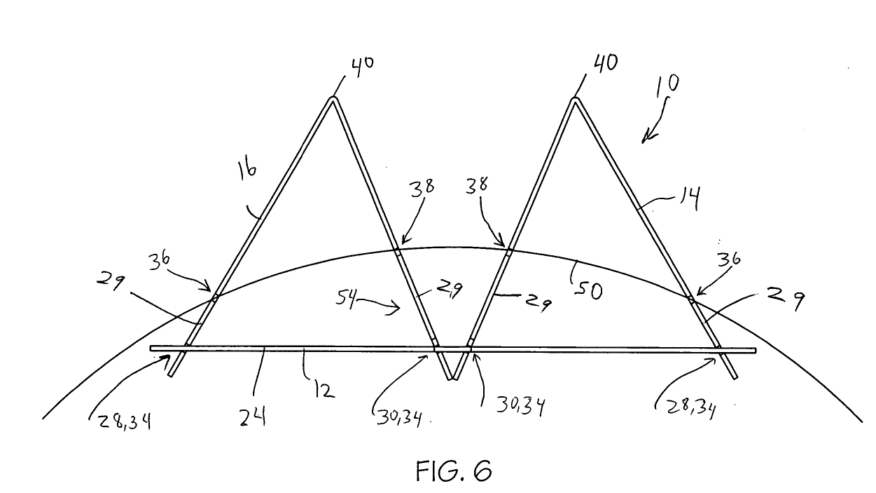

In order to mount a posterboard 50 into the posterboard display stand 10, a posterboard 50 is supplied and lowered until its lower edge 52 is received in the rear notches 36, 38 of the support portions 14, 16 (FIG. 4). The posterboard 50 can be leaned back against the support vanes 42 (FIG. 5) which support the posterboard 50 in the vertical position. As can be seen in FIG. 6, because of the shape and relative locations of the rear notches 36, 38 of the support portions 14, 16, the posterboard 50 takes on a curved shape when inserted into the rear notches 36, 38. In particular, due to the varying locations of the notches 36, 38, the notches 36, 38 define points (in this case, four points) along a curve (i.e., an arc, portion of a circle, ellipse, hyperbola, parabola, conical section, or combination of curves, or nonlinear shape, or the like) in top view. Thus, the location of the notches 36, 38 imparts a curvature to the posterboard 50 inserted therein which lends stiffness and stability to the posterboard 50. The posterboard 50 can have a variety of shapes and sizes, for example about 11 inches by 14 inches, 22 inches by 28 inches, or 24 inches by 36 inches. Thus, the posterboard display stand 10 may be of sufficient size to receive and grip posterboards having these dimensions.

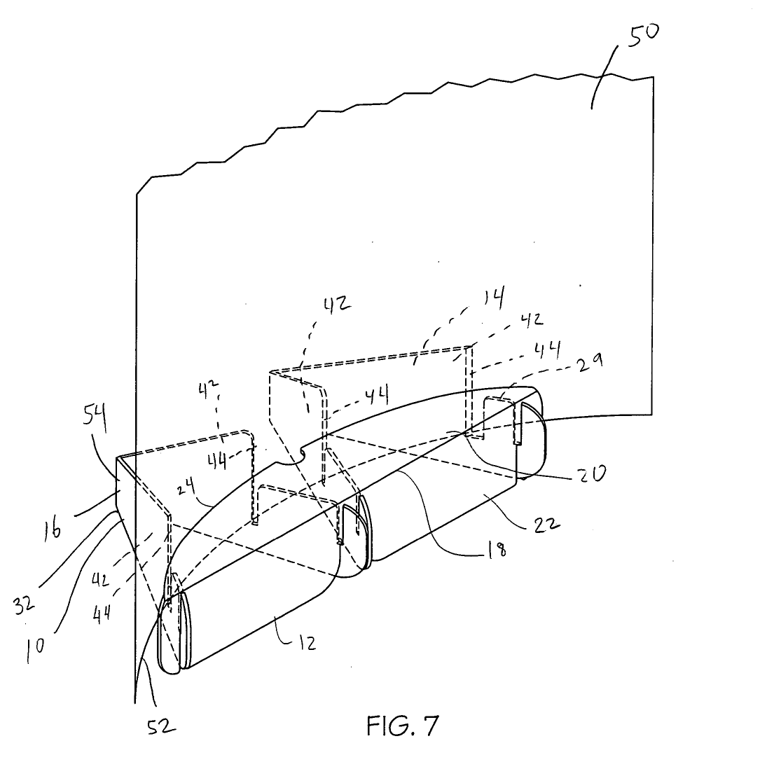

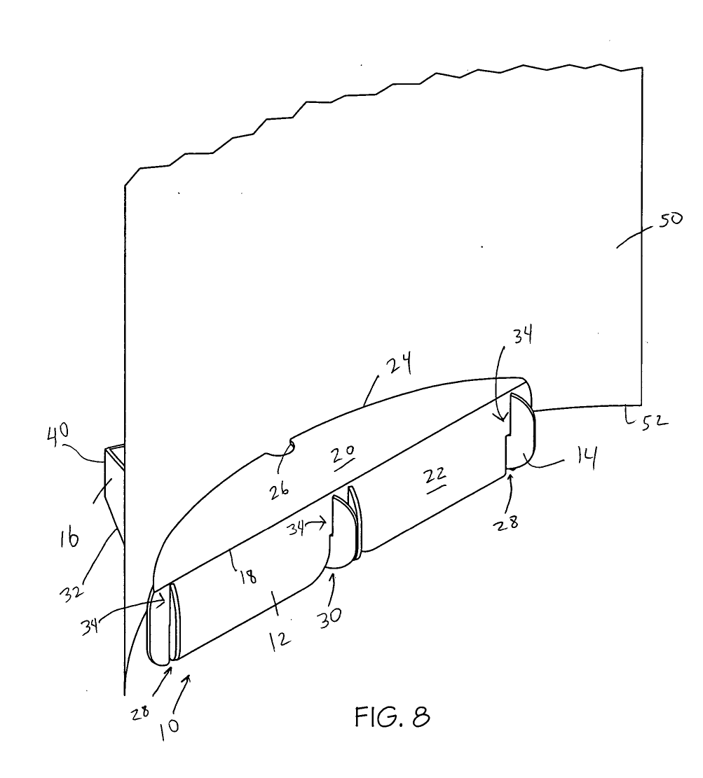

Next, in order to secure the posterboard 50 into the display stand, the movable portion 20 of the front flap 12 is pivoted about the fold line 18 and towards the posterboard 50 until the movable portion 20 engages the posterboard 50. In this position the movable portion 20 engages the flap surfaces 29 and is oriented generally perpendicular to the base portion 22 and is oriented generally horizontally (see FIGS. 7 and 8). When in this position, the curved outer edge 24 of the movable portion 20 frictionally engages the inner surface of the posterboard 50 and presses against the support vanes 42 to grip the posterboard 50 in place. In other words, when the front flap 12 is moved to its closed or gripping position, the curved outer edge 24 of the front flap 12 and/or the support vanes 42 of the support portions 14, 16 are compressed or deflected, thereby gripping the posterboard 50 therebetween.

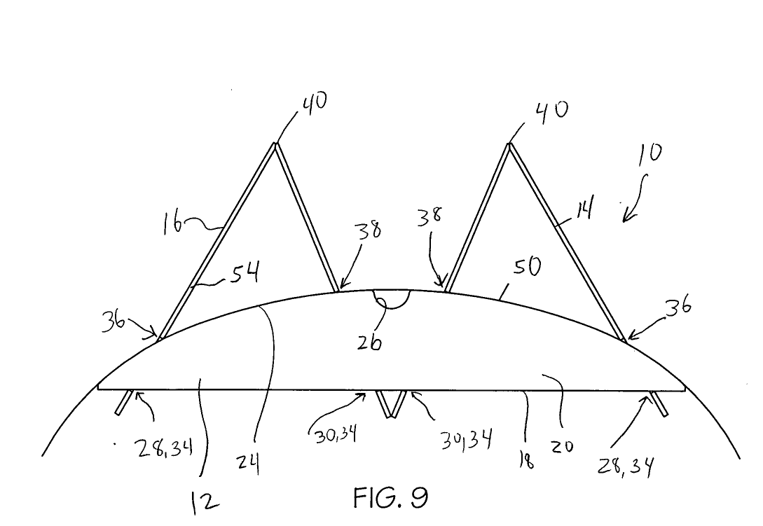

The curvature 24 of the movable portion 20 preferably generally matches the curve defined by the guide vanes 42/rear notches 36, 38 to further impart the desired curvature to the posterboard 50 (see FIG. 9). Alternately, rather than defining intermittent points along a curve, the guide vanes 42 and/or rear notches 36, 38 of the support portions 14, 16 may define a continuous curve that matches the curvature of the curved surface 24 of the front flap 22. Further alternately, or in addition, rather than defining a continuously curved surface 24 (which can be considered to include a large number or infinite number of points defining the curve), the front flap 12 may define several discrete points which define an arc or a curve.

Thus the posterboard 50 can be gripped between two continuous curved shapes, or between a continuous curved shape and a discontinuous curved shape, or between two discontinuous curved shapes. When two discontinuous curved shapes are utilized, the points defining the curve should preferably (although will not necessarily) be aligned with each other to grip the posterboard 50 therebetween when the display stand 10 is in its gripping state. Accordingly, the compressive force between the movable portion 20 and the support portions 14, 16, or the force applied by the movable portion 20, can be applied at a plurality of locations to impart curvature to the posterboard 50.

When it is desired to release the posterboard 50 from the display stand 10, the movable portion 22 of the front flap 20 is pivoted upwardly away from the gripping position and to its release position. The posterboard 50 is then frictionally released and may be lifted vertically out of the rear notches 36, 38 and thereby out of the display stand. If desired, user can insert his or her finger into the finger notch 26 of the movable portion 20 to pull the movable portion 20 to its release position. In this manner, the display stand 10 is movable between a gripping position or state (i.e., when the movable portion 20 is oriented generally horizontally) such that the display stand 10 can frictionally grip the posterboard 50, and a release position or state (i.e., when the movable portion 20 is not oriented generally horizontally) such that the posterboard 50 is not frictionally gripped by the display stand 10. The display stand 10 can include a backing portion 54 which can include the rear notches 36, 38 of the support portions 14, 16, and/or the surfaces defining the rear notches 36, 38, and/or the guide vanes 44, and/or the base portion 22 of the front flap 12, and/or all portions of the display stand 10 other than the movable portion 20 of the front flap 12.

If the display stand 10 is desired to be disassembled, the front flap 12 can be lifted vertically such that its outer 28 and inner 30 notches are lifted out of the front notches 34 of the folded support portions 14, 16. The front flap 12 and support portions 14, 16 can then be returned to their flat state (as shown in FIG. 1) for storage.

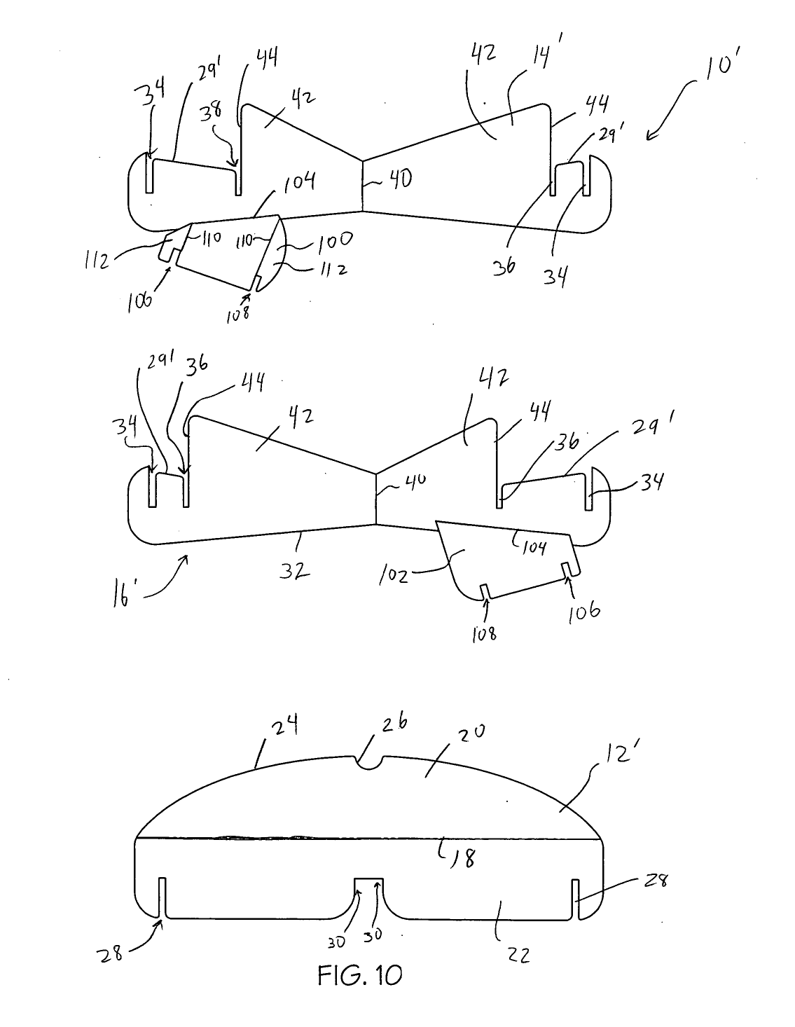

FIG. 10 illustrates an alternate embodiment of the display stand 10′ wherein each support portion 14′, 16′ includes a coupling flap 100, 102 for attaching the support portions 14′, 16′ together. Each coupling flap 100, 102, respectively, is attached to its associated support portion 14′, 16′ along a coupling flap fold line 104. Each coupling flap 100, 102 includes a pair of coupling notches 106, 108 formed in a outer edge thereof. Coupling flap 100 includes a pair of connecting flange fold lines 110 extending away from each coupling notch 106, 108. Each connecting flange fold line 110 defines a connecting flange 112 on the outer edges of the coupling flap 100. Also worth noting is the angled nature of the flap surfaces 29′ in FIG. 10, which allows the movable portion 20 to be pivoted slightly beyond a horizontal position such that the outer edge 24 is located below the fold line 18.

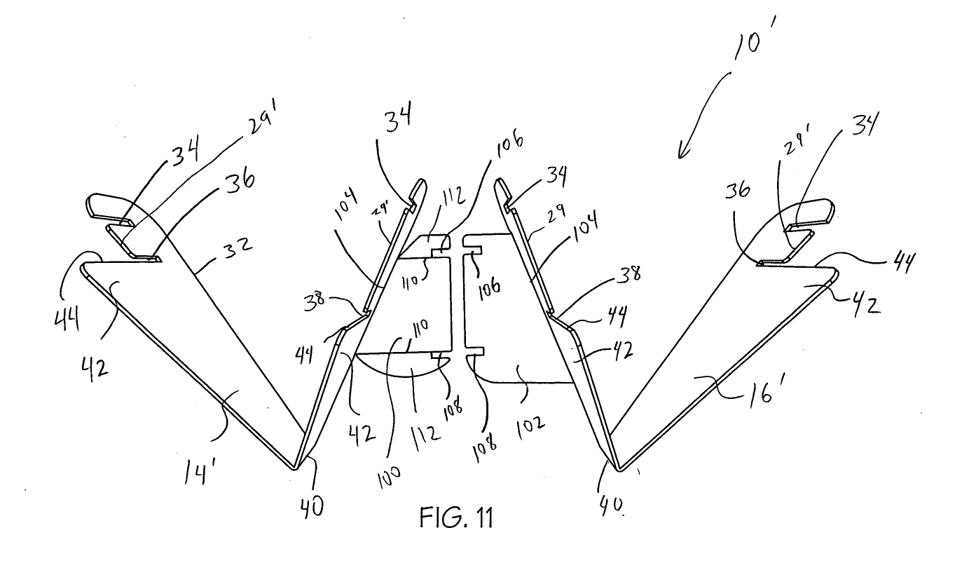

In order to assemble the components of FIG. 10, the support portions 14′, 16′ are folded about their fold lines 40 and located on the flat support surface. Each coupling flap 100, 102 is then folded about its associated fold line 104 until each coupling flap 100, 102 lies flat on the support surface and is oriented perpendicular to the support portions 14′, 16′. The support portions 14′, 16′ are then arranged such that their coupling flaps 100, 102 are facing each other (FIG. 11).

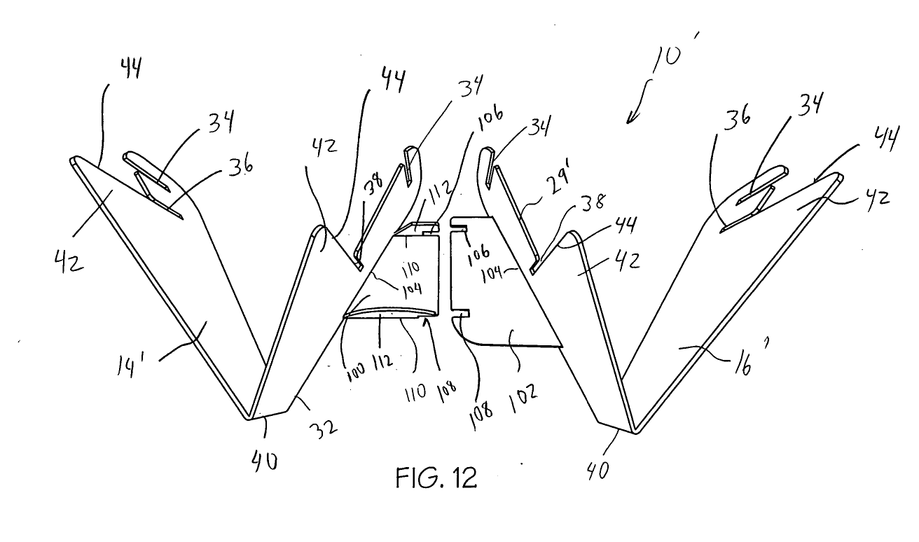

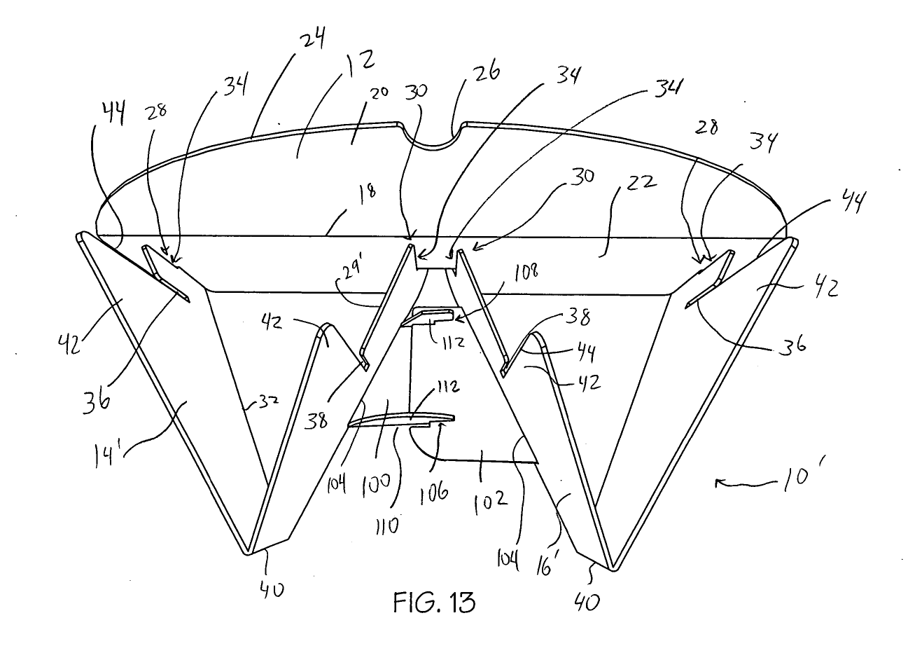

Next, each connecting flange 112 is folded along its associated connecting flange fold line 100 until the connecting flange 112 is oriented perpendicular to the main body of the coupling flap 102 (as shown in FIG. 12). The coupling flaps 100, 102 are then moved toward each other until their coupling notches 106, 108 engage each other, as shown in FIG. 13. Finally, the front flap 12 is lowered until its outer notches 28 and inner notches 30 are received in the four front notches 34 of the folded support portions 14′, 16′. In this manner, the coupling flaps 100, 102 cooperate to couple the support portions 14′, 16′ together and maintain proper alignment of the support portions 14′, 16′. In addition, the coupling flaps 100, 102 ensure that the support portions 14′, 16′ are always arranged in the proper configuration (i.e. with each of the first rear notches 36 located on the outer legs of the “M” shape, and the second rear notches 38 located on the inner legs of the “M” shape).

In addition, besides the interengaging notches 106, 108, a wide variety of coupling mechanisms can be used to couple the support portions 14′, 16′ together. For example any of a wide variety of coupling mechanisms, including but not limited to hook-and-loop fastening material (i.e., VELCRO®), clasps, brackets, clips, magnets, interengaging geometries, cords, ribbon ties, string ties, elastic ties, buttons and elastic closures and the like may be used.

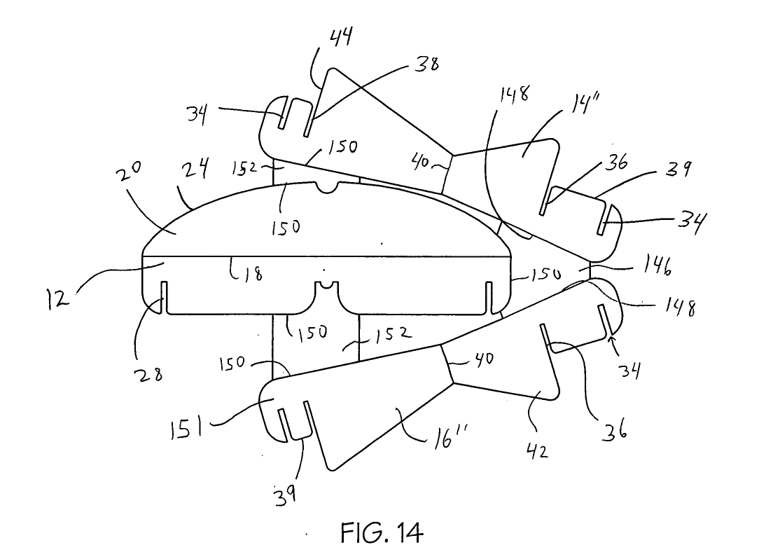

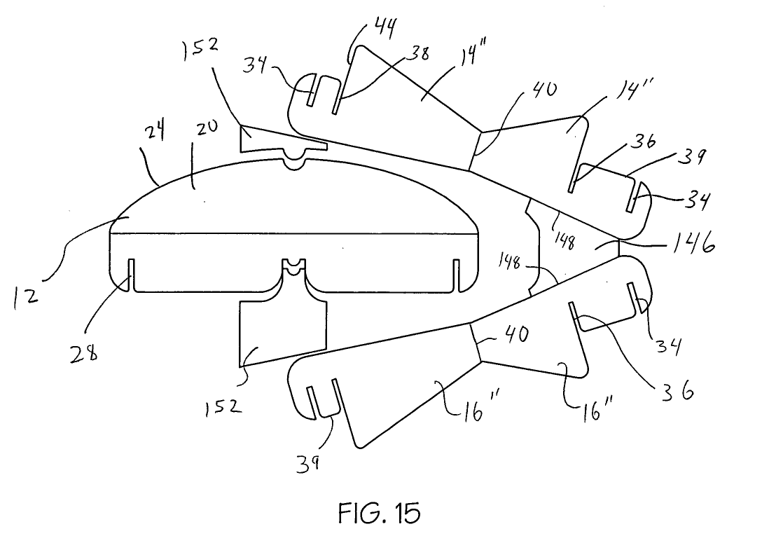

FIGS. 14-17 illustrate yet another embodiment of the invention wherein the support portions are permanently or non-removably coupled together. In FIG. 14 the various components 12, 14″, 16″ are all attached together to form a single sheet of material 151 (such as cardboard). A series of score lines, cut lines, score-slit lines or tear guide lines 150 are included in the sheet 151 to define the components 12, 14″, 16″ as well as a set of disposable attachment pieces 152. The sheet of material 151 can then be torn along the tear guide lines 150 to separate the components 12, 14″, 16″ from each other, as well as to separate the disposable attachment pieces 152 (FIG. 15). The disposable attachment pieces 152 can then be discarded.

As shown in FIG. 15, in this embodiment the support portions 14″, 16″ are coupled together by an attachment flap 146. The attachment flap 146 is fixedly secured to both of the support portions 14″, 16″, and is pivotable relative to the support portions 14″, 16″ by the attachment flap fold lines 148. The support portions 14″, 16″ and attachment flap 146 may be formed from a single, unitary piece of material.

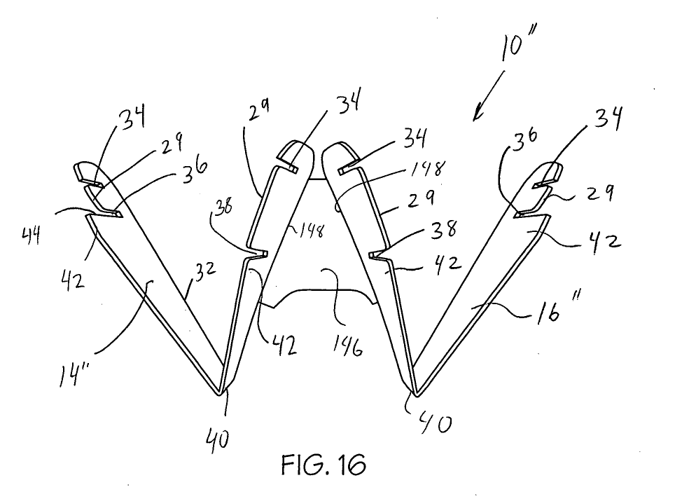

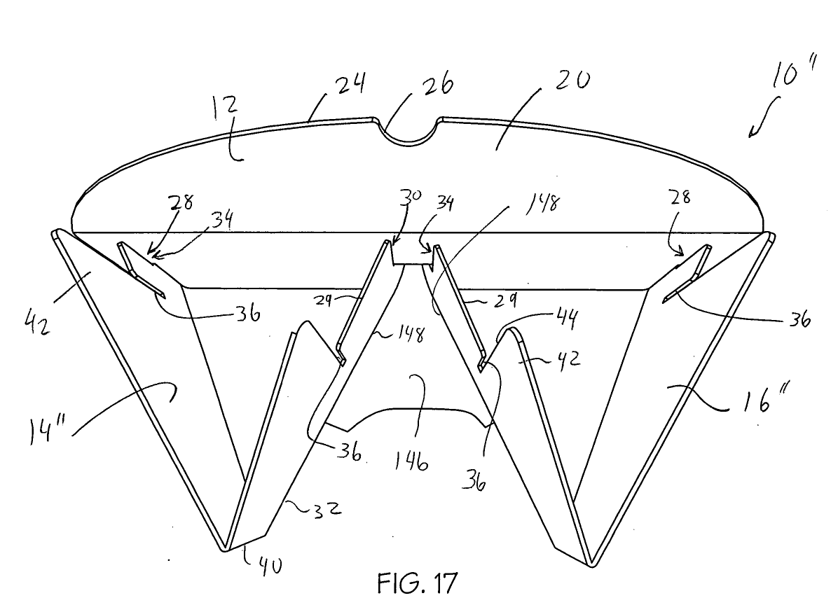

In order to assemble the components 12, 14″, 16″ of FIG. 15, the support portions 14″, 16″ are folded about the attachment flap fold lines 148 until the support portions 14″, 16″ are generally perpendicular to the attachment flap 146. The support portions 14″, 16″ are then located on the flat support surface such that the attachment flap 146 lies flat on the support surface. The support portions 14″, 16″ are then folded about their fold lines 40 to form an acute angle as shown in FIG. 16. Next, the front flap 12 is lowered until its outer notches 28 and inner notches 30 are received in the four front notches 34 of the folded support portions 14″, 16″ (FIG. 17).

The attachment flap 146 ensures that the support portions 14″, 16″ are always arranged in the proper configuration. In addition, the attachment flap 146 allows for easy and quicker assembly of the posterboard display stand 10″, since the support portions 14″, 16″ do not need to be coupled together by the user. In particular, one hand may be utilized to hold the support portions 14″, 16″ in place, while the other hand lowers the front flap 12.

Thus the posterboard display stand of the present invention can be quickly and easily assembled and disassembled. In addition, when disassembled the posterboard display stand lies flat and therefore can be placed in a compact condition for shipping or storage. Further, the posterboard display stand imparts a curvature to the posterboard which lends stiffness to the posterboard and allows the posterboard to be securely held and displayed. The relatively wide, stable footprint of the display stand provides a secure base for the posterboard. Finally, because the posterboard display stand frictionally grips the posterboard, the posterboard is securely retained in the posterboard display stand until such a time that it is desired to separate the posterboard from the display stand.

The embodiments shown herein illustrates a posterboard display stand which is movable between a gripping state and a release state. However, the posterboard display stand may not necessarily be movable between these two states. For example, the movable portion 20 of the front flap 12 may be permanently and/or fixedly retained or located in its horizontal position, or other frictional gripping arrangements may be provided. In this case, the posterboard can be slid into or out of the posterboard display stand 10 by sliding the posterboard between the front flap 20 and the support portions 14, 16, or otherwise sliding the posterboard 50 into the frictional gripping area. In this case, however, the posterboard display stand is preferably configured to impart a curvature to the posterboard.

Having described the invention in detail and by reference to the preferred embodiments, it will be apparent that modifications and variations thereof are possible without departing from the scope of the invention.

What is claimed is:

1. A posterboard display stand system comprising a display stand configured to frictionally grip a posterboard along an edge thereof and to impart a curvature thereto when said posterboard is frictionally gripped therein.

2. The display stand system of claim 1 wherein said display stand is movable between a gripping state wherein said display stand is configured to frictionally grip said posterboard and a release state in which said display stand is configured to not frictionally grip said lower edge.

3. The display stand system of claim 2 wherein said display stand includes a backing portion and a movable portion that is movable relative to said backing portion, and wherein said movable portion is in a first position when said display stand is in said gripping state and wherein said movable portion is not in said first position when said display stand is in said release state.

4. The display stand system of claim 3 wherein said display stand is configured to frictionally grip said posterboard between said movable portion and said backing portion when said display stand is in said gripping state.

5. The display stand system of claim 3 wherein said movable portion is pivotable about a generally horizontal axis.

6. The display stand system of claim 3 wherein when said movable portion is in said first position at least part of said movable portion applies a compressive force to at least part of said backing portion such that said posterboard can be gripped therebetween.

7. The display stand system of claim 6 wherein said compressive force is applied at a plurality of locations defining points along a curve to impart said curvature to said posterboard.

8. The display stand system of claim 6 wherein said movable portion includes a generally curved engagement surface which is shaped and located to apply said compressive force to said backing portion.

9. The display stand system of claim 3 wherein said backing portion includes a plurality of slots shaped to receive said posterboard therein.

10. The display stand system of claim 9 wherein said plurality of slots define points along a curve.

11. The display stand system of claim 3 wherein said movable portion is releasably coupled to said backing portion.

12. The display stand system of claim 11 wherein said display stand includes a generally flat front flap including said movable portion, and wherein said front flap further includes a body portion and a fold line located between said movable portion and said body portion, and wherein said backing portion includes a pair of support portions, each support portion being movable to a generally flat configuration and having a pair of coupling slots to receive said body portion of said front flap therein.

13. The display stand system of claim 12 wherein said support portions are directly attached together.

14. The display stand of claim 12 wherein said support portions are formed of a single unitary piece of material.

15. The display stand system of claim 1 wherein said display stand is made of cardboard.

16. The display stand system of claim 1 further comprising a posterboard frictionally gripped along its lower edge thereof by said display stand and wherein said display stand imparts a curvature to said posterboard.

17. A posterboard display stand system comprising:
a backing portion; and
a movable portion shaped to be coupled to said backing portion such that said movable portion is movable relative to said backing portion such that said backing portion and said movable portion can frictionally grip the lower edge of a posterboard therebetween and impart a curvature thereto.

18. The display stand system of claim 17 wherein when said movable portion is coupled to said backing portion said display stand is movable between a gripping state wherein said display stand is configured to frictionally grip said posterboard and a release state in which said display stand is configured to not frictionally grip said posterboard.

19. The display stand system of claim 18 wherein said movable portion is in a first position when said display stand is in said gripping state and wherein said movable portion is not in said first position when said display stand is in said release state.

20. The display stand system of claim 19 wherein when said movable portion is in said first position at least part of said movable portion applies a compressive force to at least part of said backing portion, and wherein said compressive force is applied at a plurality of locations defining points along a curve such that said curvature can be imparted to said posterboard.

21. The display stand system of claim 18 wherein said backing portion includes a plurality of slots shaped to receive said posterboard therein, and wherein said plurality of slots define points along a curve.

22. The display stand system of claim 17 wherein said display stand includes a generally flat front flap including said movable portion, and wherein said front flap further includes a body portion and a fold line located between said movable portion and said body portion, and wherein said backing portion includes a pair of generally flat support portions, each support portion having a pair of coupling slots to receive said body portion of said front flap therein.

23. The display stand system of claim 22 wherein said support portions are directly attachable together.

24. The display stand of claim 22 wherein said support portions are formed of a single unitary piece of material.

25. The display stand system of claim 17 wherein said movable portion is coupled to said backing portion and wherein the system further comprises a posterboard frictionally gripped along its lower edge thereof by said display stand and wherein said display stand imparts a curvature to said posterboard.

26. A posterboard display stand system comprising:
a backing portion; and
a movable portion that is movable to a closed position wherein said movable portion contacts said backing portion along a contact area, and wherein said contact area defines points along a curve.

27. The posterboard display stand system of claim 26 wherein said movable portion and backing portion are configured such that said movable portion and said backing portion can frictionally grip a posterboard therebetween and impart a curvature thereto.

28. A method for displaying a posterboard comprising the steps of:
providing a display stand; and
inserting a posterboard into said display stand such that said display stand frictionally grips said posterboard along an edge thereof and imparts a curvature thereto.

29. The method of claim 28 wherein said display stand includes a backing portion and a movable portion that is movable relative to said backing portion, and wherein the method includes the steps of, after said inserting step, moving said movable portion to a gripping position such that said posterboard is frictionally gripped between said backing portion and said movable portion.

30. The method of claim 29 further comprising the step of moving said movable portion to a release position such that said posterboard is not frictionally gripped between said backing portion and said movable portion.

31. The method of claim 28 wherein said display stand includes a generally flat front flap including said movable portion, and wherein said front flap further includes a body portion and a fold line located between said movable portion and said body portion, and wherein said backing portion includes a pair of support portions, each support portion being movable to a generally flat configuration and having a pair of coupling slots to receive said body portion of said front flap therein, and wherein said providing step includes providing said front flap and said support portions and coupling said front flap and support portions together to form said display stand.

32. A posterboard display stand system comprising a display stand configured to frictionally grip a posterboard along an edge thereof and to impart a non-linear shape thereto in end view when said posterboard is frictionally gripped therein.
